(19) United States
(12) Patent Application Publication
(10) Pub. No.: US 2006/0050031 A1
(43) Pub. Date: Mar. 9, 2006

(54) Display-device driving circuit suitable for inorganic electroluminescence (EL) display device

(75) Inventors: Tatsuya Suzuki, Kumagaya-shi (JP); Yasuhiro Kaneta, Isesaki-shi (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Moriguchi-shi (JP)

(21) Appl. No.: 11/217,184

(22) Filed: Sep. 1, 2005

(30) Foreign Application Priority Data
Sep. 6, 2004 (JP) 2004-258593
Sep. 6, 2004 (JP) 2004-258594

(51) Int. Cl. G09G 3/30

(52) U.S. Cl. 345/77

(57) ABSTRACT

By including a circuit that, when receiving gradation data that indicates a gradation for making a luminescence element emit light, generates a driving voltage V_{DRV} greater than or equal to a reference potential (ground potential) when a gradation indicated by the gradation data is greater than or equal to a predetermined threshold value, and that generates a driving voltage V_{DRV} less than the reference potential (ground potential), when a gradation indicated by the gradation data is smaller than the predetermined threshold value, a driving voltage V_{DRV} whose voltage value corresponds to a certain gradation for causing the luminescence element to emit light is created, and, by supplying the luminescence element with the driving voltage V_{DRV}, the luminescence element is two-side driven and made to emit light. Accordingly, the lifetime of the element is extended.

### CROSS-REFERENCE TO RELATED APPLICATION

The entire disclosure of Japanese Patent Applications Nos. 2004-258593 and 2004-258594, including their specifications, claims, drawings, and abstracts, is incorporated herein by reference.

### BACKGROUND OF THE INVENTION

1. Field of the Invention

The present invention relates to a display-device driving circuit, and more particularly to a driving circuit for an inorganic electroluminescence (EL) display device.

2. Description of the Related Art

Inorganic electroluminescence (EL) display devices are a type of know flat-panel display device. The display plane of a typical inorganic EL display device is composed of a plurality of row-electrode lines Lrow that are each consecutively arranged in parallel with one another on an insulating substrate, a high-dielectric-constant film formed on the top surface of the row-electrode lines Lrow, an intermediate layer, a phosphor layer, and an intermediate layer that are provided in that order on the high-dielectric-constant film, inorganic-EL luminous body layers that are elongated in the direction perpendicular to the row-electrode lines Lrow and are each periodically arranged in parallel with one another, and a plurality of linear column-electrode lines Lcol that are each arranged in parallel with one another on the inorganic-EL luminous body layer. The row-electrode lines Lrow and the column-electrode lines Lcol are connected to a row driver 10 and a column driver 12, respectively.

An inorganic EL display device can be represented by an equivalent circuit such as that illustrated in FIG. 13. The row driver 10 sequentially selects one out of the plurality of row-electrode lines Lrow, and a row voltage Vrow is applied to each of the selected row-electrode lines Lrow. In addition, gradation information for each pixel included in the selected row is input from an external circuit to the column driver 12, and a predetermined modulation voltage Vm is applied from the column driver 12 to each of the column-electrode lines Lcol, based on the gradation information. An electric-potential difference between the row voltage Vrow and the electric potential of each of the column-electrode lines Lcol is applied to the inorganic-EL luminous body layer for each pixel corresponding to the selected row-electrode line Lrow. As a result, the inorganic-EL luminous body layer for each pixel on the selected row-electrode line Lrow outputs light of a luminescence intensity corresponding to the electric-potential difference. Then, by implementing the foregoing control, while sequentially selecting each of rows included in the inorganic EL display device, the display screen of the inorganic EL display device is scanned, whereby a one-frame image can be displayed.

A driving circuit corresponding to each pixel in an inorganic EL display device is disclosed. As illustrated in FIG. 14, the driving circuit 50 is made up of a logic circuit 52, transistors 54 through 66, and a capacitor 68. The logic circuit 52 receives gradation data 70, converts the gradation data 70 into a pulse-width-modulation (PWM) signal 72, and outputs the converted signal. The transistor 54 is connected in series with the capacitor 68 and the transistor 56. A ramp voltage V_{R} is applied to the capacitor 68. When receiving a pulse in the PWM signal 72, the transistor 56 becomes ON, whereby the drain voltage V_{H} of the transistor 56 is kept at a threshold voltage V_{T}. In contrast, when the PWM signal 72 is not output, the transistor 56 becomes OFF, whereby the voltage V_{H} varies in accordance with the ramp voltage V_{R}. In other words, the longer the width of the PWM signal 72 is, the lower the voltage V_{H}, and the shorter the width of the PWM signal 72 is, the higher the voltage V_{H}. The transistor 64 consists of a source-follower driver circuit. A voltage V_{PP} is a sinusoidal AC power supply; an output voltage V_{OUT} of the driving circuit 50 is a voltage obtained by multiplying the voltage V_{H} by the voltage V_{PP}. Each pixel of the inorganic EL display device emits light, based on an electric-potential difference between the row voltage Vrow applied by the row driver 10 to the selected row-electrode line Lrow and the output voltage V_{OUT} applied by the column driver 12 to the column-electrode line Lcol. As illustrated in FIGS. 15A and 15B, when the electric-potential difference between the row voltage Vrow applied by the row driver 10 to the selected row-electrode line Lrow and the output voltage V_{OUT} applied by the column driver 12 to the column-electrode line Lcol is the maximal electric-potential difference ΔV_{MAX} the brightness of a pixel becomes highest; when the electric-potential difference is the minimal electric-potential difference ΔV_{MIN}, the brightness of a pixel becomes lowest. FIG. 15A illustrates the maximal electric-potential difference ΔV_{MAX} and the minimal electric-potential difference ΔV_{MIN} in a case wherein the voltages Vrow and V_{OUT} have opposite polarities, while FIG. 15B, illustrates a case wherein the voltages Vrow and V_{OUT} have the same polarity.

In addition, the voltage drop through the transistors 58 and 60 is the same as the sum of the threshold voltage V_{T} of the transistors 58 and the threshold voltage V_{T} of the transistor 60 that are the same as the threshold voltage V_{T} of the transistors 64 and the threshold voltage V_{T} of the transistor 66, respectively. As a result, the output of the driving circuit 50 does not have any “dead band”.

In a driving circuit described above, because the output voltage V_{OUT} is from 0 to 80 V and has a fixed polarity, the electric-potential difference between the voltage Vrow and the output voltage V_{OUT}, which is applied across each pixel, always has the same polarity over an electric-potential range from the maximal electric-potential difference ΔV_{MAX} to the minimal electric-potential difference ΔV_{MIN}. As described above, a one-side drive method causes a problem in that continual application of a voltage with a fixed polarity to an EL element causes a problem greatly reduces the lifetime of the EL element.

Moreover, if, in order to control the output voltage V_{OUT} through one-side drive with a fixed polarity, a necessary resolution is to be provided, the time required for control will greatly increase. For example, if the output voltage V_{OUT} Of 0 to 80 V is to be controlled with a resolution of steps, the pulse width of the PWM signal 72 as a basis should be created in accordance with the resolution of steps. Accordingly, the logic circuit 52 should create PWM signals, while counting with a counter or the like the resolution of 0 to 256. As a result, the time required for counting is great, making high-speed control difficult to achieve.

In addition, in the conventional driving circuit 50 described above, when a certain external fluctuation is added to the output voltage V_{OUT}, the high-frequency components of the external fluctuation directly affect the capacitor 68 through the parasitic capacitance C between the source and the gate of the transistor 64. As a result, a problem results in that the accumulated voltage across the capacitor 68 is susceptible to the effects of fluctuations.

### SUMMARY OF THE INVENTION

The present invention provides a display-device driving circuit in which, by creating a driving voltage that corresponds to a certain gradation for making a luminescence element emit light, and by supplying a luminescence element with the driving voltage, the luminescence element is made to emit light, the display-device driving circuit characterized by including a circuit that, when receiving gradation data that indicates a gradation for making a luminescence element emit light, generates an output voltage greater than or equal to the ground potential, when the gradation indicated by the gradation data is greater than or equal to a predetermined threshold value, and that generates an output voltage smaller than the ground potential, when the gradation indicated by the gradation data is smaller than the predetermined threshold value.

### BRIEF DESCRIPTION OF THE DRAWINGS

A preferred embodiment of the present invention will be described in further detail based on the following drawings, wherein:

FIG. 1 is a block diagram illustrating a display-device driving circuit according to an embodiment of the present invention;

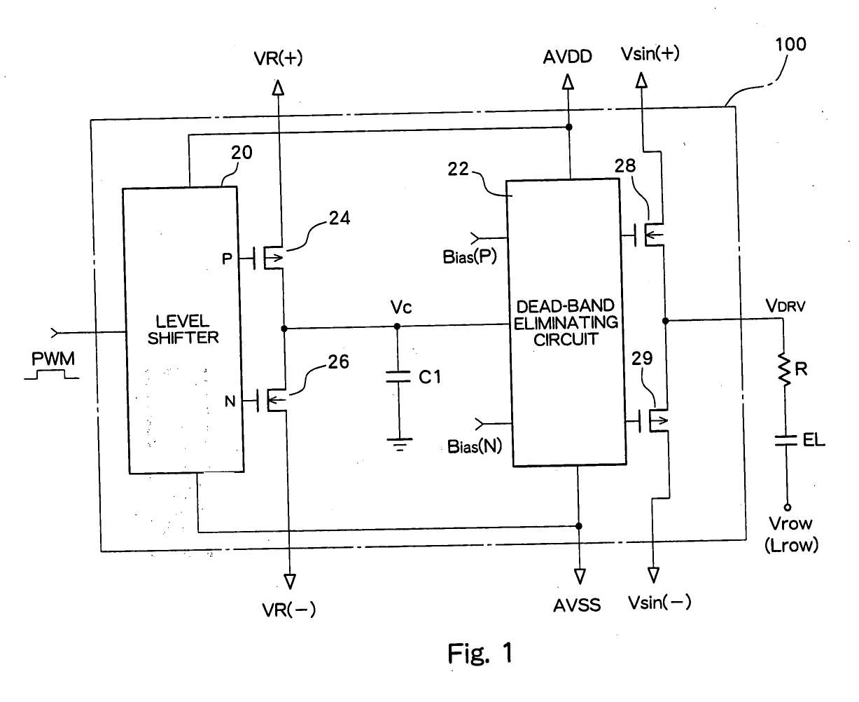

FIG. 2 is a block diagram illustrating a level shift circuit according to the embodiment of the present invention;

FIGS. 3A and 3B are diagrams for describing a pulse-width modulation according to the embodiment of the present invention;

FIG. 4 is a block diagram illustrating a specific example of a voltage shift circuit according to the embodiment of the present invention;

FIG. 5 is a diagram for describing a ramp voltage according to the embodiment of the present invention;

FIG. 6 is a diagram for describing a ramp voltage according to the embodiment of the present invention;

FIGS. 7A and 7B are diagrams for describing a relationship between a pulse-width modulated signal and a charging voltage, according to the embodiment of the present invention;

FIG. 8 is a diagram illustrating a specific example of a dead-band eliminating circuit according to the embodiment of the present invention;

FIG. 9 is a diagram for describing creation of a driving voltage, according to the embodiment of the present invention;

FIG. 10 is a diagram for describing two-side driving of a luminescence element, according to the embodiment of the present invention;

FIG. 11 is a diagram for describing two-side driving of a luminescence element, according to the embodiment of the present invention;

FIG. 12 is a block diagram illustrating an additional example of a display-device driving circuit according to the embodiment of the present invention;

FIG. 13 is a diagram illustrating an equivalent circuit of a conventional display device.

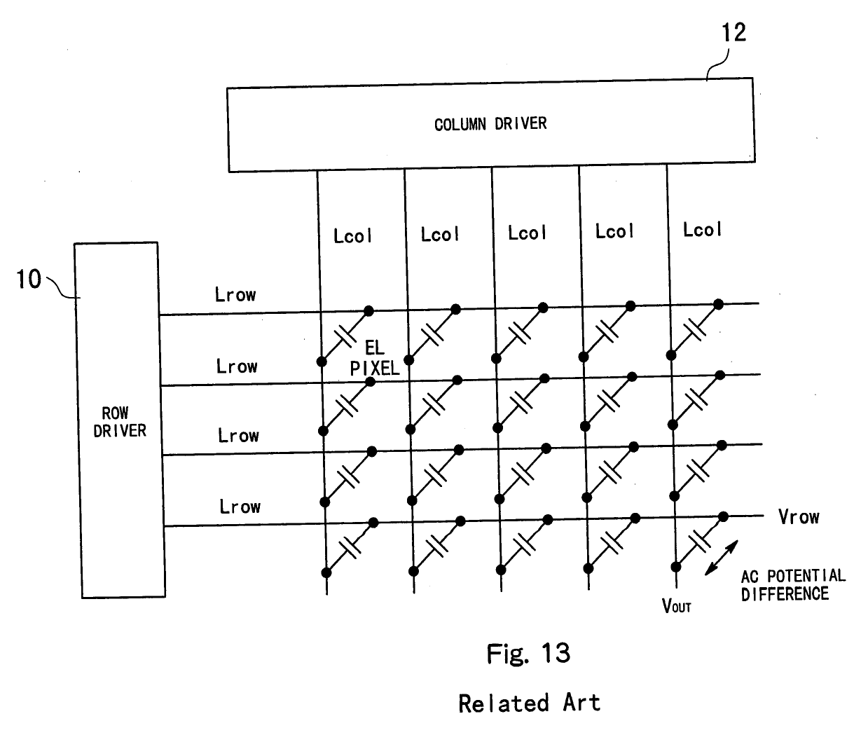

FIG. 14 is a block diagram illustrating the configuration of a driving circuit for a conventional display device; and

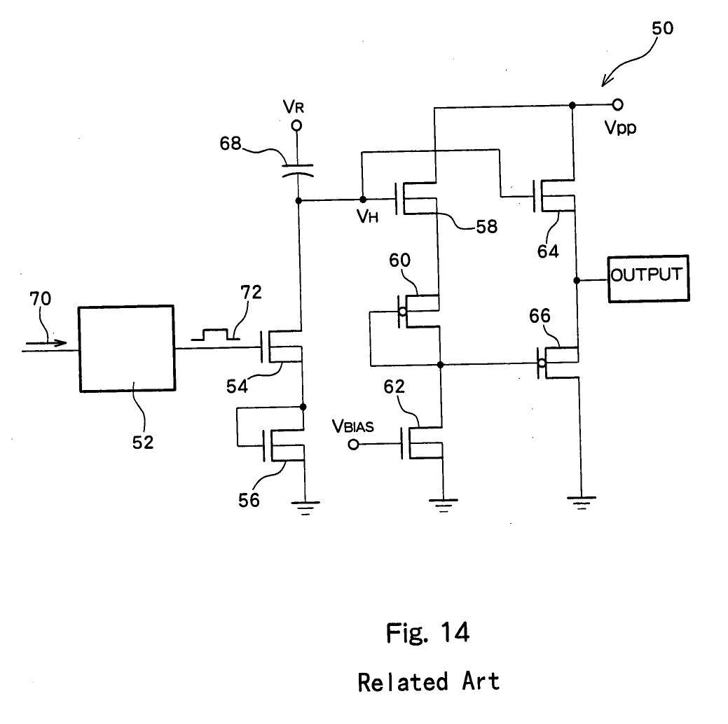

FIGS. 15A and 15B are diagrams for describing one-side driving of a conventional luminescence element.

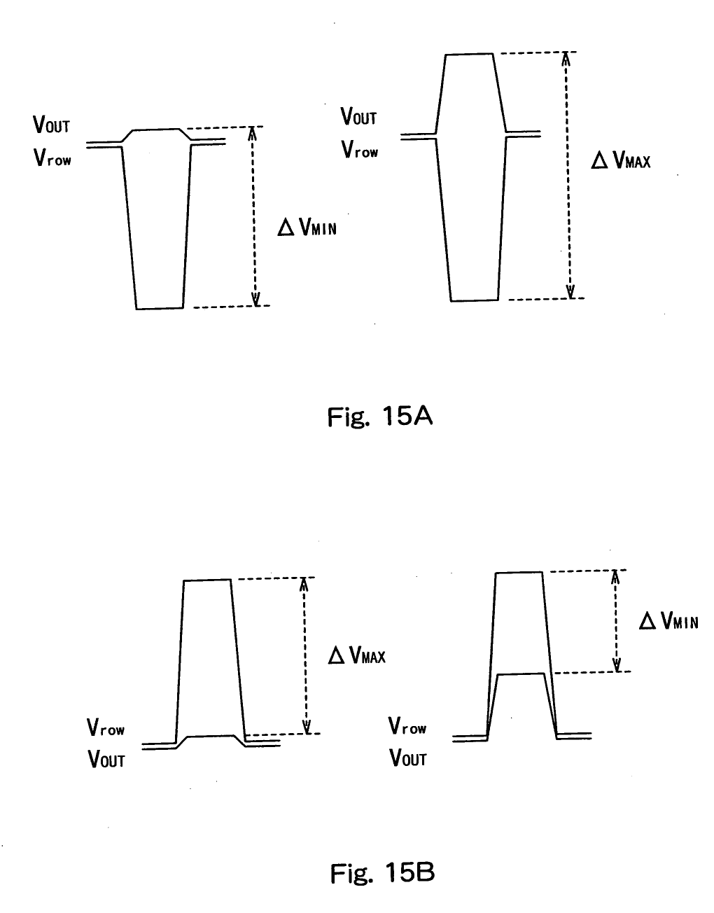

### DESCRIPTION OF THE PREFERRED EMBODIMENT

A display-device driving circuit 100 according to an embodiment of the present invention is made up of a level shift circuit 20, a dead-band eliminating circuit 22, transistors 24 through 29, and a capacitor C1.

In a conventional display-device driving circuit, a luminescence element is driven with a voltage on one side of the ground potential, for example, a voltage of 0 to 80 V. In the driving circuit 100 according to the present embodiment, a luminescence element is driven with a voltage being at both positive and negative sides with respect to the ground potential, for example, a voltage of −40 V to 40 V.

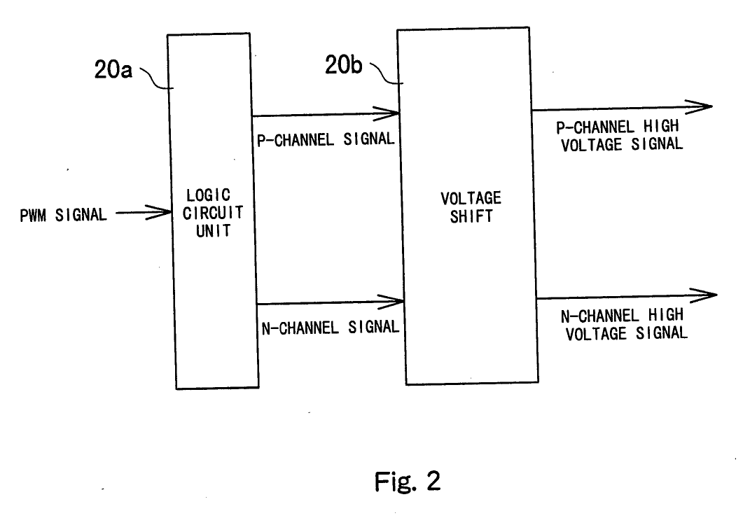

As illustrated in FIG. 2, the level shift circuit 20, comprises a logic circuit 20a and a voltage shift circuit 20b. The level shift circuit 20 corresponds to a pulse generating circuit. In addition, the voltage shift circuit 20b is supplied from outside with high-voltage power supply biases AVDD and AVSS, low-voltage power supply biases DVDD and DVSS, and gate biases Vp and high-voltage power supply biases Vn.

To the logic circuit 20a, digital gradation data that indicates the luminescence intensity of an EL element is input. When receiving the gradation data, the logic circuit 20a creates an N-channel signal or a P-channel signal that is a pulse-width coded (PWM) signal having a pulse width corresponding to the gradation data. The N-channel signal or the P-channel signal is a signal whose pulse width is in proportion to the level of the luminescence-intensity gradation for an EL element. In such a case, when the gradation indicated by the gradation data is greater than or equal to a predetermined threshold value, a P-channel signal is created that has a pulse width corresponding to the difference obtained by subtracting the threshold value from the gradation data, while, when the gradation indicated by the gradation data is smaller than the predetermined threshold value, an N-channel signal is created that has a pulse width corresponding to the gradation indicated by the gradation data. In the present embodiment, the threshold value is set to one half of the entire gradation range. Therefore, when the gradation data is smaller than the half of the entire gradation range, an N-channel signal is created and, when the gradation data meets or exceeds one half of the entire gradation range, a P-channel signal is created. In other words, the logic circuit 20a switches an N-channel signal and a P-channel signal in response to the gradation data, and outputs one or the other.

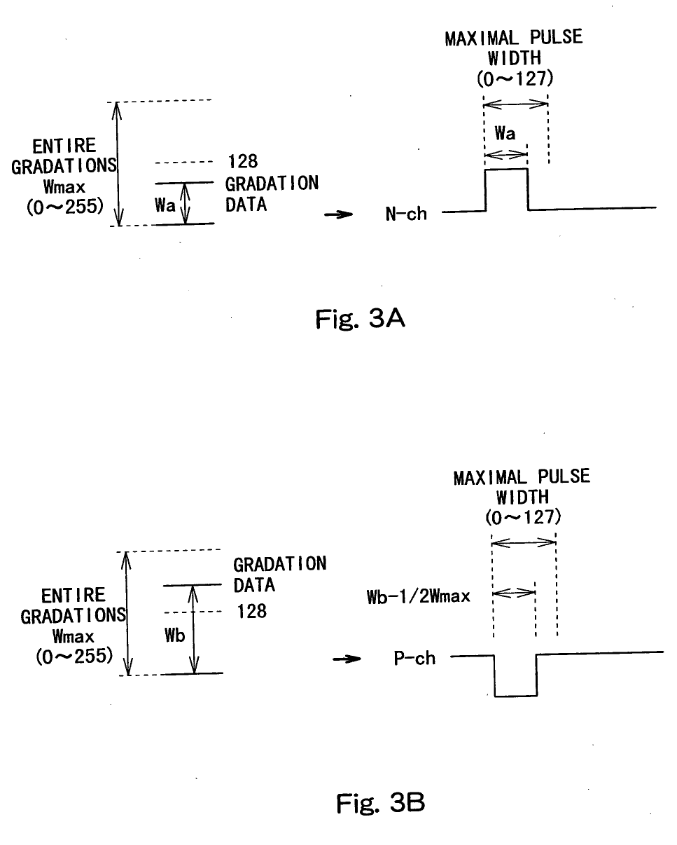

For example, when the entire gradation range is represented by the gradations of 0 to 255, as illustrated in FIG. 3A, and the gradation data is smaller than or equal to the 127th gradation, an N-channel signal is created that has a pulse width in proportion to the gradation data. The N-channel signal is created as a signal having a pulse at the negative side with respect to a reference electric potential (a ground potential, in the present embodiment) In contrast, as illustrated in FIG. 3B, when the gradation data is equal to the 128th gradation or larger, a P-channel signal is created that has a pulse width in proportion to the gradation obtained by subtracting 127 from the gradation data. The N-channel signal is created as a signal having a pulse at the positive side with respect to a reference electric potential (a ground potential, in the present embodiment). In this situation, the pulse widths of the N-channel signal and the P-channel signal are set in such a way as to have the same maximal pulse width (a pulse width corresponding to the 127th gradation).

The logic circuit 20a creates, in response to the gradation data, either one of the N-channel signal and the P-channel signal, and outputs the N-channel signal or the P-channel signal to an N-channel input terminal or a P-channel input terminal, of the voltage shift circuit 20b, respectively.

The voltage shift circuit 20b steps up the P-channel and N-channel signals output from the logic circuit 20a to high-voltage signals. The driving circuit 100 is made up of logic circuits up to the logic circuit 20a; therefore, the P-channel and N-channel signals output from the logic circuit 20a are low-voltage (e.g., 0 to V or ±3.3 V) pulse signals. Thus, in order to drive the following-stage high-voltage circuits, the voltage shift circuit 20b converts the low-voltage P-channel and N-channel signals into high-voltage signals (e.g., ±40 V).

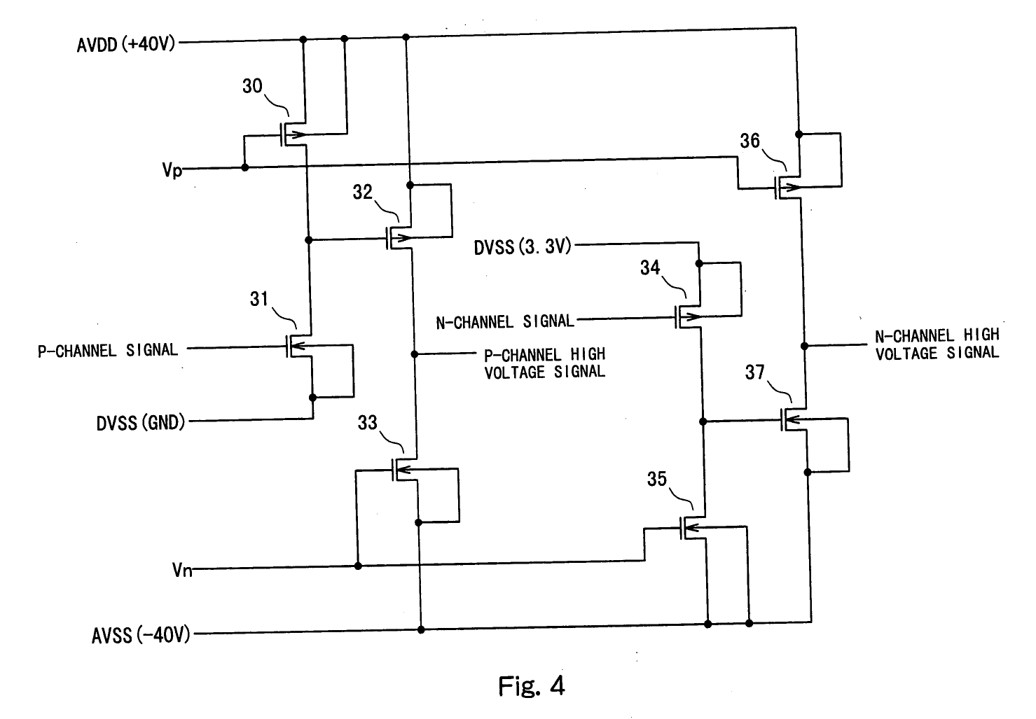

FIG. 4 illustrates an example of the voltage shift circuit 20b. Transistors 30 through 33 constitute a step-up circuit for the P-channel signal. The drain of the transistor 31 is connected to a positive high-voltage power supply bias AVDD (e.g., +40 V) through the drain and the source, of a transistor 30, while the source of the transistor 31 is connected to a low-voltage power supply bias DVSS (e.g., ground potential). The P-channel transistor 30, to the gate of which a positive gate bias Vp is applied, functions as a current source. To the gate of the N-channel transistor 31, the P-channel signal is input. The transistor 31 becomes ON while the pulse of the P-channel signal is raised, but becomes OFF while the pulse of the P-channel signal is not raised. Accordingly, the voltage at the drain terminal of the transistor 31 is kept approximately at the negative low-voltage power supply bias DVSS while the pulse of the P-channel signal is raised, but is kept approximately at the positive high-voltage power supply bias AVDD while the pulse of the P-channel signal is not raised.

The source of the transistor 32 is connected to a positive high-voltage power supply bias AVDD and the drain of the transistor 32 is connected to a negative high-voltage power supply bias AVSS (e.g., −40 V) by way of drain and source of the transistor 33. The N-channel transistor 33, to the gate of which a negative gate bias Vn is applied, functions as a current source. The drain of the transistor 31 is connected to the gate of the P-channel transistor 32; change in voltage at the drain terminal of the transistor 31 is output as the P-channel high voltage signal. In other words, because of the step-up circuit comprising the transistors 30 through 33, the P-channel signal of about 3.3 V is converted into a pulse signal of ±40 V, and the pulse signal is output.

Transistors 34 through 37 constitute a step-up circuit for the N-channel signal. The drain of the transistor 34 is connected to a negative high-voltage power supply bias AVSS (e.g., −40 V) by way of the drain and the source, of a transistor 35; the source of the transistor 34 is connected to a positive low-voltage power supply bias DVSS (e.g., +3.3 V). The N-channel transistor 35, to the gate of which a negative gate bias Vn is applied, functions as a current source. To the gate of the P-channel transistor 34, the N-channel signal is input. The transistor 34 becomes OFF while the pulse of the N-channel signal is raised, but becomes ON while the pulse of the N-channel signal is not raised. Accordingly, the voltage at the drain terminal of the transistor 34 is maintained at approximately the positive low-voltage power supply bias DVSS while the pulse of the N-channel signal is lowered, but is kept approximately at the negative high-voltage power supply bias AVSS while the pulse of the N-channel signal is not lowered.

The source of the transistor 37 is connected to a negative high-voltage power supply bias AVSS, while the drain of the transistor 37 is connected to a positive high-voltage power supply bias AVDD by way of drain and source of the transistor 36. The P-channel transistor 36, to the gate of which a positive gate bias Vp is applied, functions as a current source. The drain of the transistor 34 is connected to the gate of the N-channel transistor 37; change in voltage at the source terminal of the transistor 34 is output as the N-channel high voltage signal. In other words, because of the step-up circuit comprising the transistors 34 through 37, the N-channel signal of about +3.3 V is converted into a pulse signal of ±40 V, and the pulse signal is output.

In other words, when the gradation data is smaller than a threshold value (in the present embodiment, smaller than the 128th gradation, half of the entire 256 gradation), a pulse that has amplitude of ±40 V and a pulse width corresponding to the N-channel signal is output as the N-channel high voltage signal. When the gradation data is the same as, or larger than, the threshold value (in the present embodiment, smaller than the 128th gradation, half of the entire 256 gradation), a pulse that has amplitude of ±40 V and a pulse width corresponding to the P-channel signal is output as the P-channel high voltage signal.

The P-channel and N-channel high voltage signals output from the level shift circuit 20 are input to the gates of the transistors 24 and 26, respectively. The source of the transistor 24 is connected to a ramp voltage VR(+); the source of the transistor 26 is connected to a ramp voltage VR(−). In addition, the drains of the transistors 24 and 26 are connected to each other; the node A is grounded through the capacitor C1.

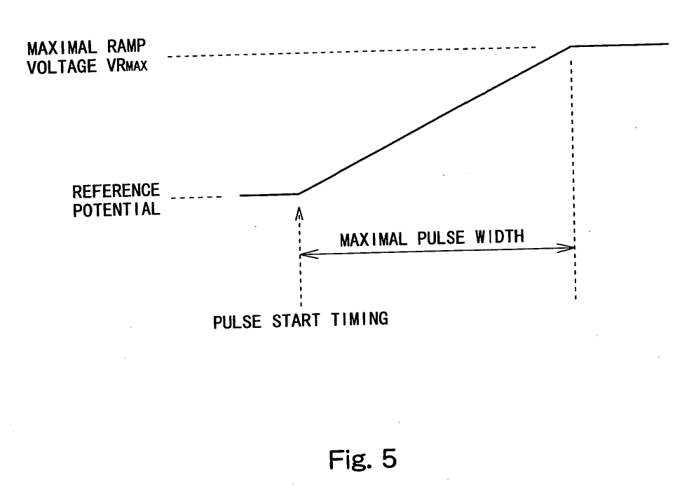

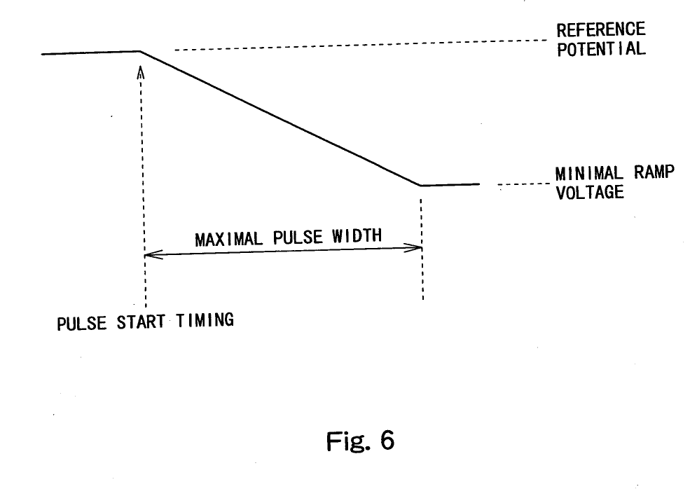

As illustrated in FIG. 5, the ramp voltage VR(+) starts to rise from a reference potential (e.g., ground potential GND), in synchronization with the timing when the PWM signal is input to the level shift circuit 20, and is stepped up, at a constant rate, so as to reach a maximal ramp voltage VR_{MAX} (e.g., +40 V) within a time corresponding to the maximal pulse width of the P-channel signal (P-channel high voltage signal). In contrast, as illustrated in FIG. 6, the ramp voltage VR(−) starts to fall from a reference potential (e.g., ground potential GND), in synchronization with the timing when the PWM signal is input to the level shift circuit 20, and is step up, at a constant speed, in such a way as to reach a minimal ramp voltage VR_{MIN} (e.g., −40 V) in a time corresponding to the maximal pulse width of the N-channel signal (N-channel high voltage signal).

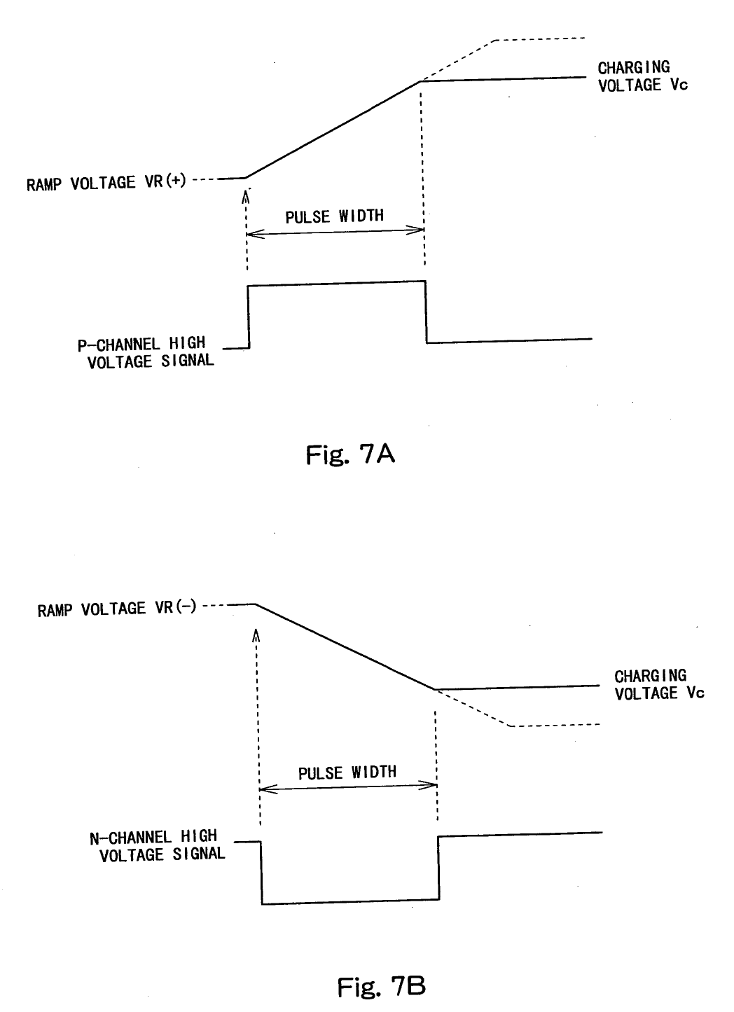

The transistor 24 becomes ON only while the pulse of the P-channel high voltage signal is output. In contrast, the transistor 26 becomes ON only while the pulse of the N-channel high voltage signal is output. Accordingly, when the pulse of the P-channel high voltage signal is output, as illustrated in FIG. 7A, the capacitor C1 is charged with the ramp voltage VR(+) in a time corresponding to the pulse width of the P-channel high voltage signal, and the charging voltage Vc across the capacitor C1 reaches a value corresponding to the pulse width. In contrast, when the pulse of the N-channel high voltage signal is output, as illustrated in FIG. 7B, the capacitor C1 is charged with the ramp voltage VR(−) in a time corresponding to the pulse width of the N-channel high voltage signal, and the charging voltage Vc across the capacitor C1 reaches a value corresponding to the pulse width.

For example, when the P-channel signal (P-channel high-voltage signal) and the N-channel signal (N-channel high voltage signal) are each output with the pulse width corresponding to a gradation in the entire 128 gradations (0 to 127th), the charging voltage Vc reaches a voltage value corresponding to the pulse width, the voltage range of 0 to 40 V or 0 to −40V being represented in 128 gradations.

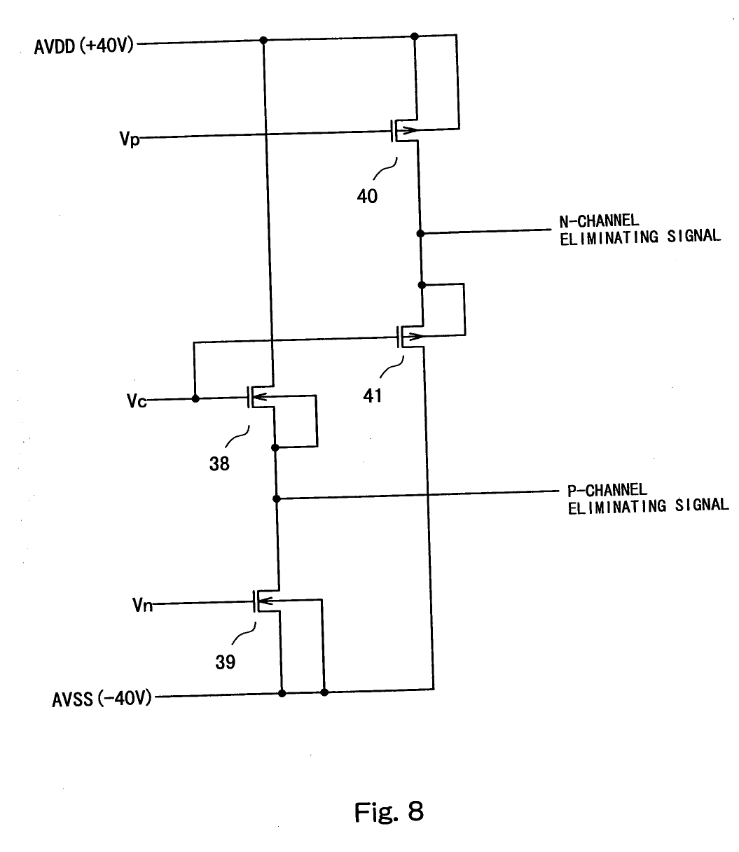

The dead-band eliminating circuit 22 receives as an input voltage the charging voltage Vc across the capacitor C1, thereby eliminating the dead band. FIG. 8 illustrates an example of the dead-band eliminating circuit 22.

The drain of the transistor 38 is connected to a positive high-voltage power supply bias AVDD, while the source of the transistor 38 is connected to a negative high-voltage power supply bias AVSS by way of drain and source of the transistor 39. To the gate of the transistor 38, the charging voltage Vc across the capacitor is input. In addition, the N-channel transistor 39, to the gate of which a negative gate bias Vn is applied, functions as a current source.

The drain of the transistor 41 is connected to a negative high-voltage power supply bias AVSS, while the source of the transistor 41 is connected to a positive high-voltage power supply bias AVDD by way of drain and source of the transistor 40. To the gate of the transistor 41, the charging voltage Vc across the capacitor is input. The P-channel transistor 40, to the gate of which a positive gate bias Vp is applied, functions as a current source.

When the charging voltage Vc becomes positive, through the action of the transistor 41 included in a source-follower circuit, the charging voltage Vc+threshold voltage Vt is output, as a N-channel eliminating signal, from the source of the transistor 41, in response to the charging voltage Vc. In contrast, when the charging voltage Vc becomes negative, through the action of the transistor 38 included in a source-follower circuit, the charging voltage Vc-threshold voltage Vt is output, as a P-channel eliminating signal, from the source of the transistor 38, in response to the charging voltage Vc.

To the gate of the transistor 28, the N-channel eliminating signal is input, while the P-channel eliminating signal is input the gate of the transistor 29. The drain of the transistor 28 is connected to a positive AC (sinusoidal) power supply Vsin(+) and the drain of the transistor 29 is connected to a negative AC (sinusoidal) power supply Vsin(−). The source of the transistor 28 is connected to the source of the transistor 29 and a driving voltage V_{DRV} for the EL device is output from the node.

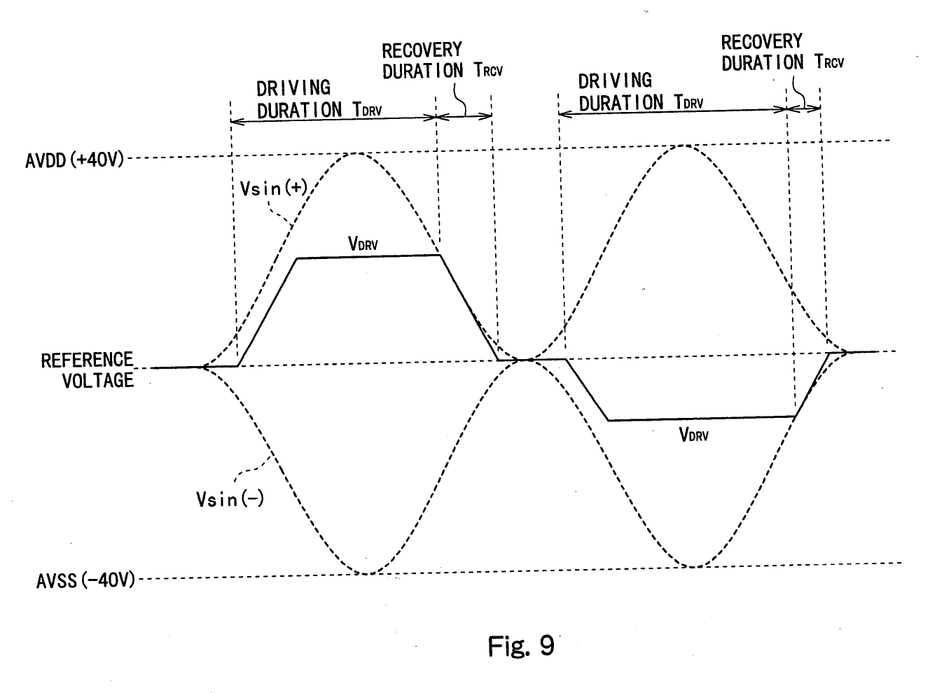

As illustrated in FIG. 9, the positive AC (sinusoidal wave) power supply Vsin(+) is a sinusoidal wave AC having a minimal peak voltage of a reference potential (e.g., ground potential GND) and a maximal peak voltage of the positive high-voltage power supply bias AVDD (e.g., +40 V). In contrast, as illustrated in FIG. 9, the negative AC (sinusoidal wave) power supply Vsin(−) is a sinusoidal wave AC having a maximal peak voltage of a reference potential (e.g., ground potential GND) and a minimal peak voltage of the negative high-voltage power supply bias AVSS (e.g., −40 V).

The transistor 29 outputs the P-channel eliminating signal+threshold voltage Vt, i.e., the driving voltage V_{DRV} corresponding to the charging voltage Vc, in accordance with the change of the P-channel eliminating signal. In contrast, the transistor 28 outputs the N-channel eliminating signal—threshold voltage Vt, i.e., the driving voltage V_{DRV} corresponding to the charging voltage Vc, in accordance with the change of the N-channel eliminating signal.

In this situation, the voltage drop across the transistor 28 is compensated for by the threshold voltage V_{T} of the transistor 41, and the voltage drop across the transistor 29 is compensated by the threshold voltage V_{T} of the transistor 38; therefore, the output of the driving circuit 100 does not have any “dead band”.

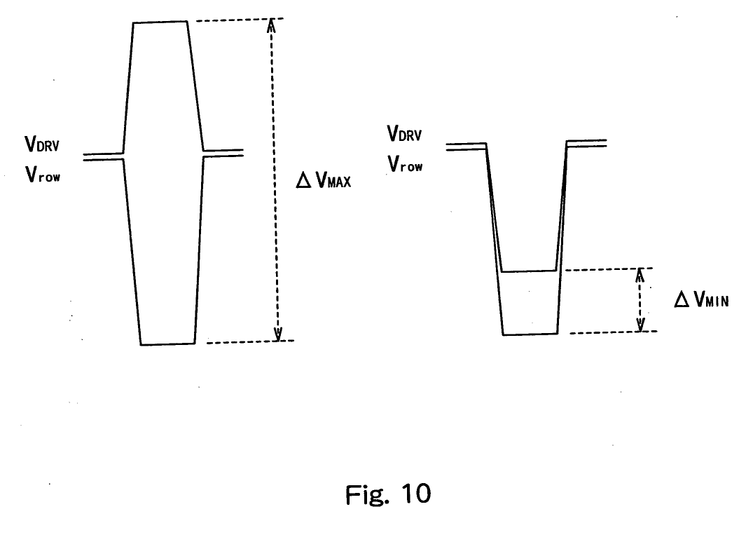

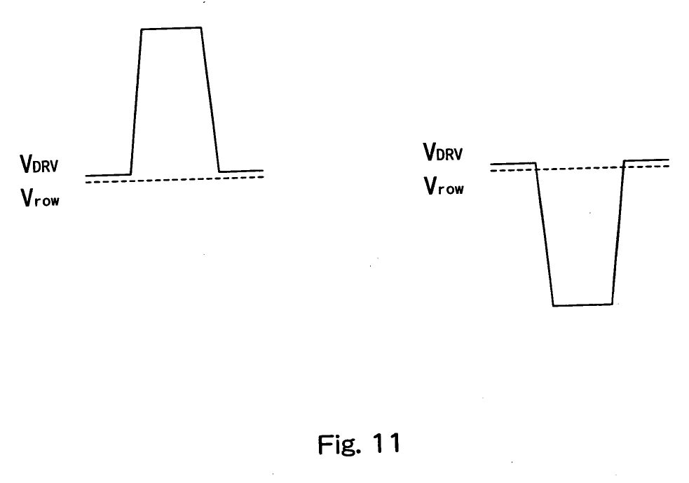

Accordingly, as illustrated in FIG. 10, to the EL device connected to a selected row-electrode line Lrow, the electric-potential difference between the voltage Vrow that is applied to the row-electrode line Lrow and the driving voltage V_{DRV} that alternate positive and negative with respect to a reference potential (ground potential) is applied, over a range of ΔV_{MIN} to ΔV_{MAX}. The electric-potential difference causes the luminescence element to emit light of a luminescence intensity in accordance with the gradation data. In contrast, as illustrated in FIG. 11, to the EL device connected to a non-selected row-electrode line Lrow, the electric-potential difference between the reference potential (ground potential) and the driving voltage V_{DRV} that swing positive and negative with respect to the reference potential (ground potential) is applied. As a result, it is possible to extend the lifetime of the EL element significantly longer than that of a conventional EL element.

Moreover, because the driving voltage V_{DRV} is controlled through two-side driving having positive and negative polarities, in the positive and negative polarities, respective resolutions may be less than the entire resolutions. For example, when the threshold value is one half of the entire range of gradations, the resolution in each polarity may similarly be half of the entire resolutions. When, as in the present example, there are a total of 256 gradations, and the threshold value is half of the entire gradations, i.e., 128, the respective resolutions may be 128 gradations in positive and negative polarities. Accordingly, the logic circuit 20a may create the N-channel and P-channel signals, while counting the resolutions of 0 to 127 using a counter or the like. Therefore, it is possible to make the counting time shorter than that of a conventional logic circuit, and thereby enhance the speed of control.

Moreover, even when a certain external fluctuation such as a surge is added to the driving voltage V_{DRV} and is transferred through the parasitic capacitance of the transistors 28 and 29, the extent to which the external fluctuation affects the capacitor C1 can be reduced by the transistors 38 and 41 of the dead-band eliminating circuit 22.

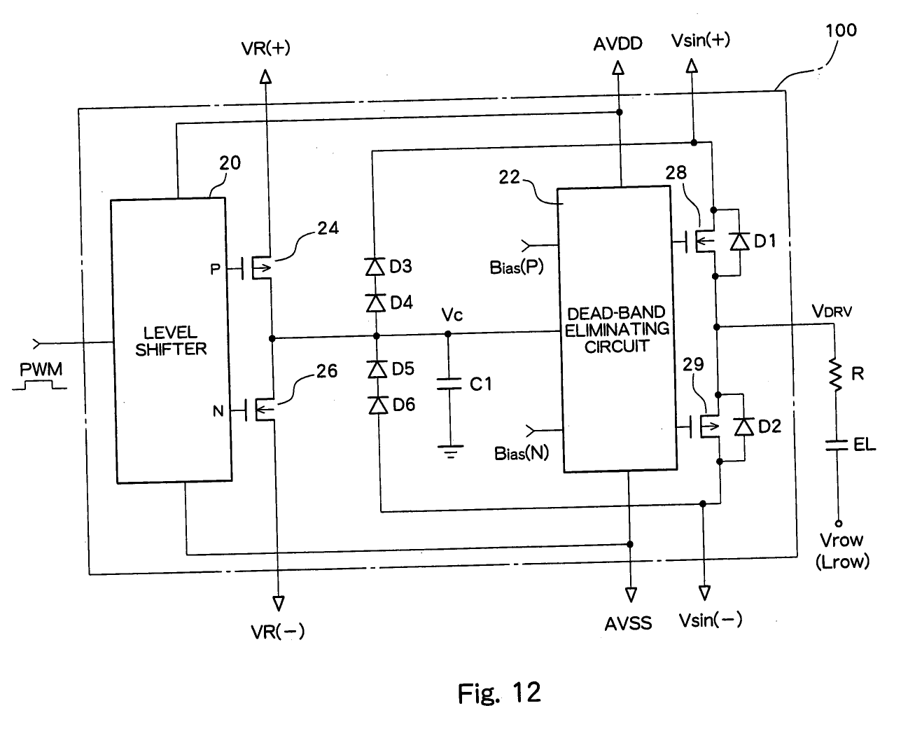

In addition, as illustrated in FIG. 12, the driving circuit 100 may include power-recovery diodes D1 and D2 for recovering energy stored in the EL element, for the power supplies. Accordingly, as illustrated in FIG. 9, during the recovery duration T_{RCV} that follows the driving duration T_{DRV}, energy stored in the EL element can be recovered by AC power supply Vsin(+) or Vsin(−). In this situation, it is appropriate to provide in the driving circuit 100 power-recovery diodes D3 through D6 for effectively recovering electric power. For example, when a positive voltage (electric charges) is stored in capacitance of an EL element, the charges flow during the recovery duration to the AC power supply Vsin(+) by way of the diode D1. In this situation, the charges stored in the capacitor C1 also flow to the AC power supply Vsin (+), but the voltage Vc across the capacitor C1 is higher than the AC power supply Vsin (+), by the voltage across the diode D3 and D4. Accordingly, the P-channel transistor 29 becomes OFF, whereby electric power can be effectively recovered. Similarly, when a negative voltage (electric charges) is stored in capacitance of an EL element, the transistor 28 becomes OFF owing to the action of the diodes D5 and D6, whereby electric power can be effectively recovered by the AC power supply Vsin(−).

Although an inorganic EL display device has been described as an example display device, the present invention is not limited to inorganic EL display devices, and any display device can be utilized in the present invention, as long as the display is of a type utilizing an element that can emit light in response to application of a bipolar voltage. In this regard, however, in a display device, such as an inorganic EL display device, whose applied voltage is over a range of several tens of volts, enabling two-side driving, i.e., positive and negative driving can achieve demonstrable effects such as prolonging the lifetime of the luminescence element or enabling reduction in the voltages that must be withstood by devices included in the driving circuit.

As explained above, according to the present invention, because two-side driving of a luminescent device with a driving voltage having both positive and negative polarities is employed, the lifetime of the luminescent device can be extended. Moreover, the two-side driving method utilizing both positive and negative polarities can speed up the control. Furthermore, effects of external fluctuation on the driving voltage can be reduced.

What is claimed is:

1. A display-device driving circuit for, by creating a driving voltage that corresponds to a gradation for making a luminescence element emit light, and by supplying the luminescence element with the driving voltage, making the luminescence element emit light, the display-device driving circuit comprising a circuit that, when receiving gradation data that indicates a gradation for making a luminescence element emit light, generates an output voltage the same as, or higher than, the ground potential, when the gradation indicated by the gradation data is the same as, or larger than, a predetermined threshold value, and that generates an output voltage smaller than the ground potential, when the gradation indicated by the gradation data is smaller than the predetermined threshold value.

2. The display-device driving circuit according to claim 1, wherein the luminescence element emits light of a luminescence intensity corresponding to an electric-potential difference between a voltage applied to a row-electrode line and a voltage applied to a column-electrode line, and, in making the luminescence element emit light, a driving voltage corresponding to the output voltage is applied to the column-electrode line of a luminescence element having the row-electrode line to which a voltage which differs from the ground potential is applied.

3. The display-device driving circuit according to claim 2, wherein the luminescence element is an inorganic electroluminescence (EL) element.

4. The display-device driving circuit according to claim 1, comprising a pulse generating circuit in which, when a gradation indicated by the gradation data is the same as, or larger than, the threshold value, a first signal is created that has a pulse width corresponding to the difference obtained by subtracting the threshold value from the gradation indicated by the gradation data, and when a gradation indicated by the gradation data is smaller than the threshold value, a second signal is created that has a pulse width corresponding to the gradation indicated by the gradation data, and wherein either an output voltage that is the same as, or higher than, the ground potential and is corresponds to the pulse width of the first signal that has been created in the pulse generating circuit is generated, or an output voltage that is lower than the ground potential and is corresponds to the pulse width of the second signal that has been created in the pulse generating circuit is generated.

5. The display-device driving circuit according to claim 4, comprising:
a first transistor, to the gate of which the first signal is applied and to the source of which a positive ramp voltage is applied, the positive ramp voltage being raised with time from the ground potential to a maximal ramp voltage; and
a second transistor, to the gate of which the second signal is applied and to the source of which a negative ramp voltage is applied, the negative ramp voltage being lowered with time from the ground potential to a minimal ramp voltage, a circuit in which the drains of the first and the second transistor are connected, and the connecting point is connected to one terminal of a capacitor, and the ground potential is applied to the other terminal of the capacitor.

6. The display-device driving circuit according to claim 5, wherein the first transistor becomes ON only during duration corresponding to the pulse width of the first signal, and the second transistor becomes ON only during duration corresponding to the pulse width of the second signal.

7. The display-device driving circuit according to claim 1, wherein a dead-band eliminating circuit is provided that eliminates a dead band in the output voltage.

8. The display-device driving circuit according to claim 7, wherein the dead-band eliminating circuit comprises an N-channel transistor, to the gate of which the output voltage is applied, to the drain of which a first power supply voltage that is higher than the ground potential is applied, and to the source of which a second power supply voltage that is lower than the ground potential is applied; and a P-channel transistor, to the gate of which the output voltage is applied, to the drain of which the second power supply voltage is applied, and to the source of which the first power supply voltage is applied.

9. The display-device driving circuit according to claim 7, comprising a pulse generating circuit in which, when a gradation indicated by the gradation data is the same as, or larger than, a predetermined threshold value, a first signal is created that has a pulse width corresponding to the difference obtained by subtracting the threshold value from the gradation indicated by the gradation data, and when a gradation indicated by the gradation data is smaller than the threshold value, a second signal is created that has a pulse width corresponding to the gradation indicated by the gradation data, and wherein either an output voltage that is the same as, or higher than, a reference potential and is corresponds to the pulse width of the first signal that has been created in the pulse generating circuit is generated, or an output voltage that is lower than the reference potential and is corresponds to the pulse width of the second signal that has been created in the pulse generating circuit is generated.
